(19) United States
(12) Patent Application Publication
(10) Pub. No.: US 2019/0394526 A1
(43) Pub. Date: Dec. 26, 2019

(54) SYSTEM, METHOD, APPARATUS AND COMPUTER PROGRAM PRODUCT TO ANALYZE SYSTEM LOG INFORMATION AND DETERMINE USER ACTIONS

(71) Applicant: INTERDIGITAL CE PATTENT HOLDINGS, PARIS (FR)

(72) Inventors: Jaideep CHANDRASHEKAR, Palo Alto, CA (US); AJITH PUDHIYAVEETIL, Palo Alto, CA (US)

(21) Appl. No.: 16/467,115

(22) PCT Filed: Dec. 1, 2017
(86) PCT No.: PCT/US17/64134

§ 371 Date: Jun. 6, 2019

Related U.S. Application Data
(60) Provisional application No. 62/436,096, filed on Dec. 19, 2016.
(60) Provisional application No. 62/520,205, filed on Jun. 15, 2017.

(51) Int. Cl. H04N 21/442; G06F 9/54; G06F 9/451; G06Q 30/02; G06F 11/30; H04N 21/431; H04N 21/45

(52) U.S. Cl. CPC H04N 21/44222; G06F 9/542; G06F 9/451; G06Q 30/0255; H04N 21/44204; G06F 11/302; H04N 21/4312; H04N 21/4532; G06F 11/3072

(57) ABSTRACT

System, method, apparatus and computer program product to process information regarding operation of a system and determine a characteristic of a user interaction with the system that is then used to improve the system operation.

### TECHNICAL FIELD

The present principles generally relate to systems, methods, apparatus and computer program products to process information regarding operation of a system and determine characteristics of user interaction with the system that are then used to improve the system operation.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Traditional approaches to delivery of content to a user and consumption of content by a user, e.g., home entertainment by watching broadcast (managed) television, are slowly being supplemented, and in some cases replaced, by Over-the-Top (OTT) delivery of multimedia content. One example of such OTT content delivery comprises delivery of multimedia content such as video streams over (or on top of) the broadband network service provided by an Internet service provider (ISP). With the proliferation of OTT platforms and applications, user attention and time is fragmented, preventing any particular platform or provider from gaining a holistic understanding of the user, their content consumption habits, and profiles. An understanding of such qualities, preferences or habits of a user may be useful for various reasons. For example, a provider of multimedia content may wish to recommend content to a user and adapt the system operation to provide improved recommendations according to a user and the user's attributes or habits. To do so, a content provider must be able to determine a user's interactions with a device.

However, much of the OTT streaming today is enabled by so called OTT boxes (Apple TV, Android TV, Roku, etc.), which are embedded platforms where individual applications are instantiatated as ‘applications’ or apps. These are isolated or “sandboxed” from each other, and have no visibility into the operation of one another making it difficult to track or follow a user's interactions with the system and determine actions a user is taking, content that is being accessed, etc.

### SUMMARY

In accordance with an aspect of the present principles, an exemplary embodiment comprises a method including accessing a log of operations of a system to obtain a series of log entries associated with an active application executed by a processor included in the system; comparing the series of log entries to a plurality of patterns of log entries stored in a database to identify a pattern corresponding to the series, wherein each of the plurality of patterns in the database being associated with an action by a user; repeating the accessing and comparing steps to identify a plurality of actions by the user; and compiling the plurality of actions to create a record of an interaction of a user with the system.

In accordance with another aspect, an exemplary embodiment comprises an apparatus including a memory; and a processor coupled to the memory and being configured to: access the memory to obtain from a log of operations of the apparatus stored in the memory a series of log entries associated with an active application executed by the processor; compare the series of log entries to a plurality of patterns of log entries in a database stored in the memory to identify a pattern corresponding to the series, wherein each of the plurality of patterns in the database being associated with an action by a user; repeat the access and compare operations to identify a plurality of actions by the user; and compile the plurality of actions to create a record of an interaction of a user with the apparatus.

In accordance with another aspect of the present principles, an exemplary embodiment comprises a method including accessing a log of operations of a system and configuration information of the system indicating an application program available in the system, processing log entries in the log and the configuration information to create a database of log entries associated with interactions of a user during execution of the application program, accessing the database to obtain a series of log entries associated with an active application executed by a processor included in the system; comparing the series of log entries to a plurality of patterns of log entries stored in a database to identify a pattern corresponding to the series, wherein each of the plurality of patterns in the database being associated with an action by a user; repeating the accessing and comparing steps to identify a plurality of actions by the user; and compiling the plurality of actions to create a record of an interaction of a user with the system.

In accordance with another aspect, an exemplary embodiment comprises an apparatus including a memory; and a processor coupled to the memory and being configured to: access the memory to obtain from a log of operations of the apparatus stored in the memory a series of log entries associated with an active application executed by the processor; compare the series of log entries to a plurality of patterns of log entries in a database stored in the memory to identify a pattern corresponding to the series, wherein each of the plurality of patterns in the database being associated with an action by a user; repeat the access and compare operations to identify a plurality of actions by the user; and compile the plurality of actions to create a record of an interaction of a user with the apparatus.

In accordance with another aspect, an exemplary embodiment comprises a system providing content to a remote device, receiving data representing log entries from the remote device wherein each log entry provides an indication of an event of an over-the-top (OTT) application operating on the remote device, processing the data to determine a characteristic of an interaction between a user of the remote device and the OTT application, repeating the receiving and processing steps to determine parameters of the use of the remote device by the user, generating an analysis of the parameters, and modify the operation of system in response to the analysis to adapt the content provided to the remote device by the system in accordance with the use of the remote device.

In accordance with another aspect, an embodiment of generating an analysis of the parameters and modifying operation based on the analysis may comprise one or more of:

generating an overview of how a service is being used across a population of OTT subscribers such as the plurality of applications being used at any given time, the number of subscribers active at any given time, etc.; generating a dashboard representation of the overview; and controlling the service in response to the dashboard;

tracking subscriber behavior across the set of OTT applications available on the device; and controlling the service in response to tracking subscriber behavior;

identifying one or more clusters of “similar” subscribers based on records of OTT consumption; and controlling the service to deliver different publicity, or advertisements, or offers of differentiated service to a specific one or ones of the clusters;

determining a characteristic of a subscriber action across different OTT applications, wherein the characteristic may comprise a duration of browsing for content before commencing playback in a certain OTT platform; and modifying a user interface in response to the characteristic;

identifying a latent factor comprising one or more of geography (e.g., a location of the user), demographics (e.g., a demographic attribute of the user), a broadband speed available to the user, etc., influencing a user's selection of a particular OTT platform at a particular time; and controlling the service in response to the latent factor;

identifying a latent factor comprising one or more of geography, demographics, broadband speed, etc., influencing a characteristic of a user's use of the service, wherein the characteristic comprises a level of a user's engagement with an application; and modifying the service in response to the latent factor;

determining a likelihood of a subscriber to the service to use an OTT application at a particular time of day; and controlling the service in response to the likelihood;

predicting a level of engagement of a body of subscribers with an OTT application at a particular time of day; and controlling the service in response to the level of engagement.

These, and other aspects, features and advantages of the present disclosure will be described or become apparent from the following detailed description of the preferred embodiments.

### BRIEF DESCRIPTION OF THE DRAWINGS

The following detailed description is to be read in connection with the accompanying drawings wherein like reference designators indicate the same or similar features and wherein:

FIG. 1 shows a first example of a list of entries from a system log;

FIG. 2 shows a second example of a list of entries from a system log;

FIG. 3 illustrates in block diagram form an exemplary embodiment of a system for processing log entries such as those shown in FIGS. 1 and 2;

FIG. 4 illustrates in flowchart form an exemplary embodiment of a method in accordance with the present principles; FIG. 5 illustrates in block diagram form an exemplary embodiment of an apparatus in accordance with the present principles; and

FIG. 6 illustrates in block diagram form an exemplary embodiment of an apparatus and/or system in accordance with the present principles.

It should be understood that the drawings are for purposes of illustrating the concepts of the disclosure and are not necessarily the only possible configuration for illustrating the disclosure.

### DETAILED DESCRIPTION

Embodiments of the present disclosure will be described herein below with reference to the accompanying drawings. In the following description, well-known functions or constructions are not described in detail to avoid obscuring the present disclosure in unnecessary detail.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for instructional purposes to aid the reader in understanding the principles of the disclosure and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In general, an embodiment in accordance with the present principles comprises a method to determine user interactions with OTT applications by processing data included in the system logs of an electronic apparatus, e.g., a set-top box (STB), mobile device, digital television (DTV), gateway device, etc. The present principles are generally applicable to various types of devices operating using various types of operating systems, e.g., the Android ecosystem.

During the operation of such electronic devices, each application running or executing on a device during the course of its execution by a processor included in the device may cause the processor to write or store information regarding the actions or operations of the application to a system log as part of normal operation of the device and the application. This information is intended to enable an application programmer to follow the internal state of the application and the device as the device carries out various operations and, e.g., may be useful as a tool to diagnose problems.

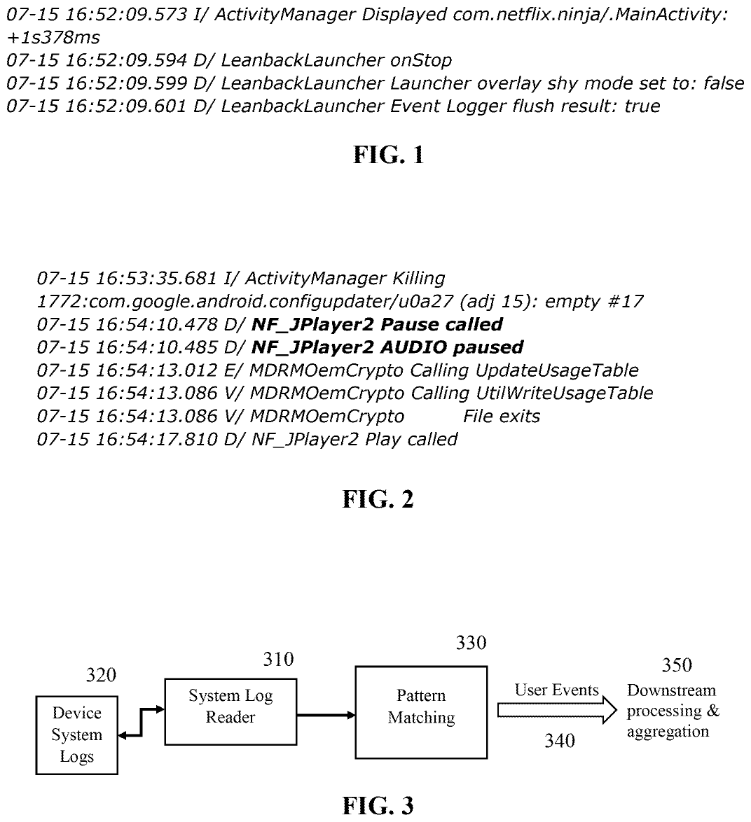

In accordance with an aspect of the present principles, the log entries written to the device system log during execution of an application comprise strings of data such as the examples shown in FIG. 1. The log entries are recognized as a proxy for, or as having an attribute of representing, the state of the application. Stated differently, the log entries or messages being written to the system log capture and represent at a high level what an application is doing at a particular time.

When a user interacts with a device executing an OTT application, the user may select or activate a particular action or follow a certain sequence of actions that typically is one of a small set of possible actions. For example, a user may open an application such as Netflix, browse for content, start a video stream, pause it (or rewind/fast-forward through it), stop the video stream, and so on. Typically, actions a user may take for a particular application are limited to a small, discrete set of possible actions that are well defined for a particular device and application.

Another aspect of the present principles comprises reconstructing the occurrence of a user's actions inside an OTT application (which are not explicitly visible outside of the application itself), by examining the system logs. As a first example, a set of log lines (or entries or strings) reported or recorded or stored in a system log each time a user launches a Netflix OTT application is shown in FIG. 1. As a second example, a set of log lines reported or stored each time the user starts a video in the Netflix OTT application is shown in FIG. 2.

Another aspect of the present principles comprises building a database of patterns of log strings corresponding to or correlated with particular events. System logs may then be accessed and log strings compared to the database. Matches between log strings extracted from the system logs and log strings in the database enable identifying the user actions associated with the log strings from the system logs. Further processing of the identified user actions, e.g., compiling actions that occur and correlating the actions with when the actions occur (e.g., time of day from the system log entries), enables determining or extracting user behavior from the system log data.

In accordance with another aspect, in general it is recognized that the log strings may vary by software versions, e.g., of the operating system (OS) and individual OTT applications. As a result, the database of patterns corresponding to events would be constructed once for each software version. Also, the database of patterns may be created in advance by an entity such as a provider of a particular system or device and made available, e.g., stored in a memory or in the cloud, for access by an exemplary embodiment operating as described herein. Alternatively, the database may be created by a device such as upon initial boot up for applications stored in the system or device or accessible in the cloud or upon installation of a particular application in a system or apparatus.

FIG. 3 shows an exemplary system in accordance with aspects of the present principles described herein. Portions or all of the system shown in FIG. 3 may be in a device such as a set top box (STB) or gateway or mobile device or other device in a user's location such as a home, e.g., consumer premises equipment (CPE), or may be partially in a user's location and partially elsewhere such as in the “cloud”, at a head end device (e.g., at a content provider or network service provider (NSP)). In FIG. 3, a system log reader 310 such as a processor, microprocessor, system on a chip or software executing on a processor accesses system logs 320 that may be stored in any of various types of memory and reads log entries. The log entries are processed during pattern matching 330 which may occur in the same processor as that accessing the system log reader 310, e.g., a particular software routine executed by a processor, and/or in a separate processor. The pattern matching compares sequences of log entries to sequences of entries in the database of log entry patterns to identify user actions or events. The user events information 340 may be provided to an entity such as a network service provider (NSP) for downstream processing 350.

In accordance with another aspect of the present principles, the exemplary system shown in FIG. 3 provides for processing system log entries or data to produce information regarding user behavior. Actions included in downstream processing and aggregation 350 shown in FIG. 3 may cover a number of potential uses or scenarios for producing and utilizing user behavioral information. For example, behavioral profiles of individual users may be developed based on the user events and/or actions identified from the system log entries and used to facilitate and improve content recommendation. For example, if a content provider obtains user behavioral information in accordance with the present principles that indicates a user activates a Netflix application and accesses content on Netflix most or all evenings at or around 8:00 PM then the content provider may give Netflix content, e.g., a particular Netflix series, a high priority in any list of content recommended to a user. As another example, information for actions of a plurality of users may be aggregated, e.g., to produce information regarding behavior for all users in a household. Such behavioral information is valuable to content providers who may use the information to improve their services such as content recommendation and to users who receive an improved service and/or increased efficiency of their device or system, e.g., less time devoted to searching for content.

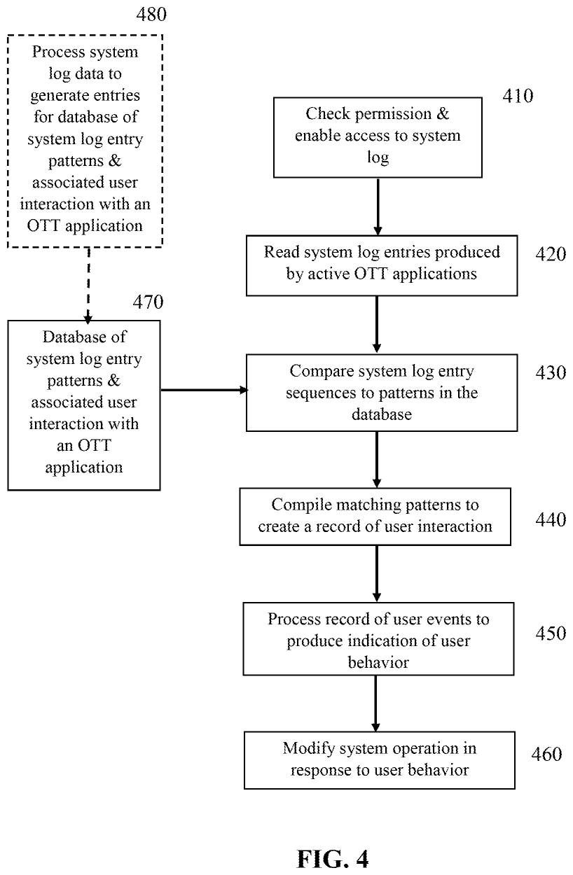

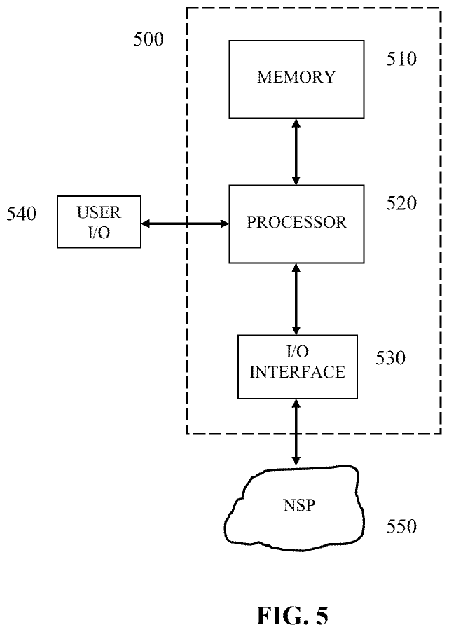

In general, another exemplary embodiment in accordance with aspects of the present principles comprises a method as shown in FIG. 4 that may be performed by a processor. For example, a processor may be programmed with a software routine that, when executed by the processor, implements the exemplary method shown in FIG. 4. In FIG. 4, at step 410, in response to a request to access the system log, the system checks permission to access the system log. If the permission is correct, access is granted and system log entries for active OTT applications are read from the log at step 420. At step 430, the log entries read from the system log at step 420 are compared to log entry sequences in a database of log entries. That database may be an existing database, e.g., one created previously by a service provider, NSP, head-end system, mapping each possible action, operation or event for an OTT application to a log entry pattern or sequence. If a previously generated database exists, the log entry retrieved from the system log at step 420 and log entry patterns retrieved from the existing database at step 470 are compared at step 430.

In an alternative embodiment, a database may not exist or an existing database may require updating (e.g., following installation of a new OTT application) and the system may generate or update the database at step 480. At step 480, the system maps log entries to events or operations of OTT applications such as in the following exemplary manner. Each action or operation of an OTT application is activated. As each operation executes, entry of log entries in the system log is tracked and log entry strings or patterns resulting from each operation are stored in the database with a mapping or corresponding entry indicating the corresponding OTT application action for each string or pattern. That is, the system accesses the system log following execution of known user actions for particular OTT applications and uses the information to generate a database of system log entry patterns associated with each type of user interaction with an OTT application. For example, a particular OTT application may be activated, each possible user event or interaction with the OTT application initiated, and the resulting sequence of log entries saved to the database as representing or being matched to the particular event or action. Following creation of the database at step 480, the database is available at step 470 to provide log strings or patterns to the above-mentioned comparison at step 430.

At step 430, system log entries from step 420 and database entries from the database available at step 470 are compared to identify entries in the system log that match known sequences in the database. Matches indicate user events that occurred and sequences of those events. The event data is compiled at step 440 to create a record of user events or user interactions with the OTT application and/or the system. In addition to events, the compilation at step 440 may include characteristics of a particular occurrence of an event, e.g., day of the week, time of day, user's location (e.g., geographic coordinates from GPS information), etc., that may undergo subsequent processing to further define user behavior such as when a particular event or type of event may typically occur for a particular user. This subsequent processing occurs at step 450 and produces an indication of user behavior. For example, step 450 may occur at a head end facility such as a NSP to determine when a user typically accesses broadcast content such as local news, when a user typically accesses special content such as content from an OTT provider such as Netflix, etc. Alternatively, the subsequent processing of step 450 may occur partially or completely in a user's device such as CPE equipment.

The processing at step 450 may be followed by a variety of results or actions. For example, a user's behavior may result in modification of the system providing a service or content to improve the service or system operation. As a specific example, if a user accesses a particular OTT application or content at a particular time of day, the service provider may modify a user interface such as a “favorites list” to place the OTT application and/or content associated with the application at the top of, or near the top, of the favorites list. As another example, an electronic program guide (EPG) produced by the service may be modified to display the indicated application and/or associated content in a prominent manner in the program guide, e.g., in a particular location or in a particular color or in a particular font, etc.

In general, another exemplary embodiment in accordance with aspects of the present principles comprises apparatus as shown in FIG. 5. In FIG. 5, a device 500 may be apparatus such as a set top box or one of various other types of electronic equipment as mentioned herein that may be a CPE device, a mobile device, etc. Device 500 includes a processor 520 configured to communicate with a memory 510 to store and access software such as OTT applications, software for programming the processor to execute the method shown in FIG. 4, and data such as system logs and a database correlating OTT application events to known system log entry sequences. Additional or other memory resources either internal or external to device 500 may also be available to and accessed by processor 520. Processor 520 receives and responds to commands from user I/O (input/output) unit 540. Examples of embodiments of unit 540 include, but are not limited to, a remote control, mobile device, tablet, laptop, and devices that recognize or respond to user movements, such as hand motions, and/or verbal user commands. For example, a user may use activate an OTT application and control the processor executing the OTT application to initiate certain actions that are recorded in the system logs by the processor writing log entries into memory 510 corresponding to a user requesting or activating OTT application events by user I/O unit 540. Device 500 also includes an I/O interface 530 configured to enable processor 520 to communicate with external devices, entities and resources such as NSP 550 shown in FIG. 5 (which may, for example, comprise resources in the “cloud”), for example, to provide user event information to an entity such as NSP 550 for downstream processing such as evaluating or utilizing user behavioral information and to receive content and/or content recommendations from NSP 550. Communication between device 500 and NSP 550 via I/O interface 530 may occur via one or more of various paths such as wired or wireless connections including, but not limited to, cable (e.g., CATV), Internet, Ethernet, WiFi, Bluetooth, etc.

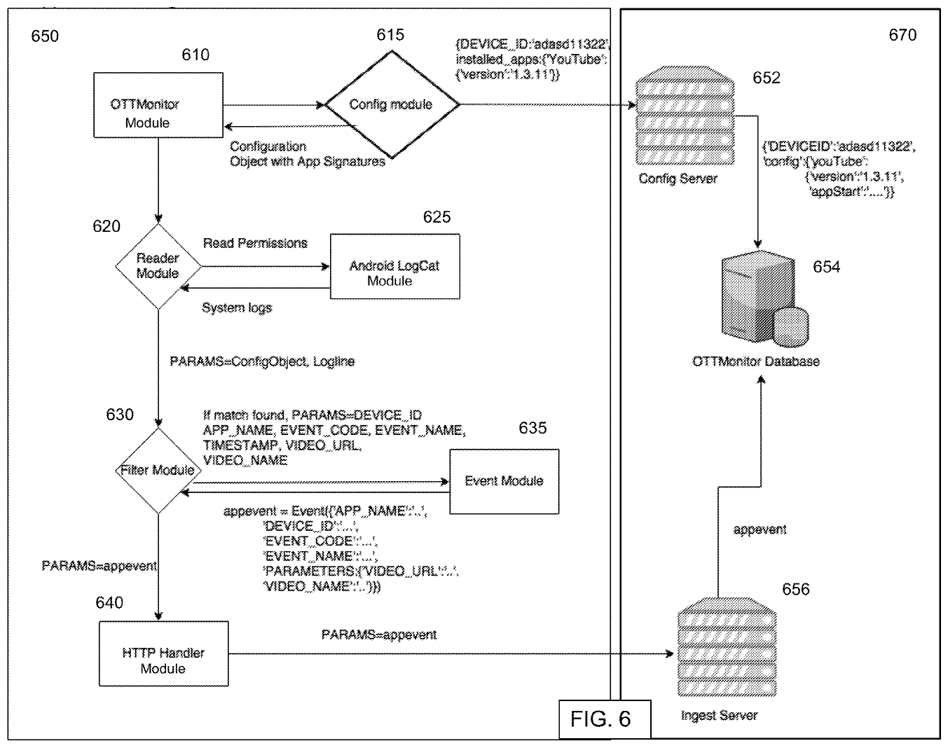

FIG. 6 shows an exemplary embodiment of a system in accordance with the present principles. The system of FIG. 6 comprises an exemplary embodiment of an OTT monitor system 650 that may be included in a CPE device such as a digital set top box or other exemplary devices described above. System 650 may, for example, comprise software, hardware or a combination of both. In an embodiment, system 650 may include various hardware and/or software modules that operate as described below. That is, the modules included in system 650 in FIG. 6 may be implemented in hardware with the hardware modules communicating via signals connecting the hardware modules as shown in FIG. 6. Also, the modules of system 650 may be software. For example, the modules may correspond to steps of a method implemented in software or routines within a software program suitable for operation or execution by a CPE device operating using an operating system such as the Android operating system. As will be apparent to one skilled in the art, applications intended for use with operating systems other than Android, e.g., Apple's iOS operating system, are also possible examples of application 650. For ease of explanation, the description that follows of the embodiment of FIG. 6 will only be in regard to the Android operating system. However, the features and operation described are also applicable to other operating systems.

As shown in FIG. 6, system 650 may communicate with devices external to a CPE device 670 that may include server devices and/or memory or data storage devices that, for example, may be located at a headend or service provider and may be referred to as a “back-end” or headend portion of the system. Also, the illustration of system 650 in FIG. 6 may correspond to a software routine suitable for implementation using a hardware configuration such as that shown in FIG. 5. That is, a processor such as processor 520 may operate in response to a software routine stored in memory 510 to implement OTT application monitoring features of system 650 of FIG. 6 as explained below.

In more detail, operation of system 600 begins when module 610 initiates operation of OTT application monitoring. Module 615, labeled Config module, communicates with a server at a service provider or headend such as configuration server 652 to maintain or obtain configuration information for the CPE device. For example, module 615 may operate to obtain information regarding the configuration of the CPE device such as applications that are installed in the CPE device, e.g., YouTube or Netflix. The configuration information enables system 650 to initiate operation to attempt to determine actions of a user when interacting with one or more applications installed in the CPE device.

Initiation of operation at module 610 causes a check for permission to access the operation log data by module 620. If permissions are correct, i.e., system log access is permitted, a pipe to the system log data is opened. That is, module 625, labeled Android LogCat Module, provides system log data to Reader Module 620 in response to log data requests. More specifically, once the pipe is established, module 620 generates a request for system log data. Module 625 processes valid requests for log data, retrieves log data from the log data database, and returns the data to module 620 for further processing. The retrieved log data may include lines or strings of data from the stored log of operations of the CPE device where each line or string of log data may represent a particular action of a user or operation of the CPE device. Module 620 then passes the received log data to a filtering operation at module 630 labeled Filter Module. Module 630 compares the log data, e.g., lines or strings of information from the stored log, to known log data patterns. Such known patterns of log data may be accessed and retrieved from a memory or database accessible to module 630 (e.g, database 470 described above in regard to FIG. 4). Lines or strings of log data that do not match known patterns are removed or eliminated from further consideration and processing. For a log line or log lines matching a known pattern in the database, module 630 passes parameters of the matching line to module 635 labeled Event Module. Such parameters may include, for example, a device identifier (device ID), application name (e.g., Netflix), event name (e.g., launch application), a timestamp, etc. Module 635 determines the application action or operation that corresponds to parameters of a matching log line and creates an event that describes the operation and application involved, e.g., “launch Netflix”. The created event is returned to module 630 with event parameters. Module 630 then passes parameters of the event to module 640 which converts the event information to an HTTP object that, for example, may be sent to headend 670 for further processing. It will be readily apparent to one skilled in the art that while module 640 creates an HTTP object, HTTP is merely an exemplary protocol selected for the object created by module 640. Any protocol would be suitable.

Continuing with FIG. 6, information regarding the application events occurring in the CPE device such as the event information provided by the HTTP objects may be received at headend 670 by, for example, ingest server 656. Server 656 may store and/or process the event information and provide the application event information to a database such as OTT Monitor Database 654 in FIG. 6. Database 654 may also receive application configuration information from configuration server 652 of headend 650 to enable the headend or service provider to analyze and correlate application events with installed applications for a particular user and user's CPE device and/or for multiple users and their respective CPE devices using the service. Such correlation of events and applications and analysis at the headend further enables a service provider to combine and analyze the usage information for multiple users to, for example, control the service provided or improve the service provided.

A description of some exemplary uses to which the present principles can be applied will now be given. Of course, the following is merely illustrative and not exhaustive. The system of FIG. 6 and the other embodiments described herein can be utilized in various alternative embodiments or ways. For example, as mentioned above, an OTT vendor or service provider may receive and process data from system logs of remote devices to determine characteristics or parameters of a user's use of applications such as OTT applications or use of the remote device to interact with such applications to modify or improve the operation of the system accordingly. As more specific examples, a system determining such characteristics or parameters may utilize the information to:

construct a dashboard across a population of OTT subscribers in order to get an overview of how the vendor's service is being used; for example, the overview may show the plurality of applications being used at any given time, the number of subscribers active at any given time, etc.; and/or

track subscriber behavior across the set of OTT applications available on the device; and/or

identify clusters of “similar” subscribers based on records of OTT consumption; such clusters may be targeted with different publicity or advertisements, or offers of differentiated service; and/or

understand and track subscriber behavior across different OTT applications; for example, if subscribers browse for content longer before commencing playback in a certain OTT platform, this is potential feedback that could impact the design of a user interface (UI) of the service or platform; and/or

identify latent factors (geography (e.g., a location of the user), demographics (e.g., a demographic attribute of the user), a broadband speed available to the user, etc.) that influence why subscribers select particular OTT platforms (over others), at particular times; and/or

identify latent factors (geography, demographics, etc.) that influence why certain applications have higher engagement than others; and/or

identify time of day when subscribers, or individual clusters, are likely to watch certain OTT applications; and/or

predict the engagement of a body of subscribers with a specific OTT application (and at a time of day).

Although certain above-described features of FIG. 6 and application thereof have been explained in the context of an exemplary embodiment in headend 670, it will be readily apparent to one skilled in the art that such features may be implemented in other contexts or devices. For example, in an embodiment, features such as analysis of user interaction with OTT applications and improvement of the system based on the analysis may occur in a CPE device. In more detail, a processor of a CPE device such as processor 520 of FIG. 5 as described herein may receive event parameter information from module 630 of FIG. 6 instead of or in addition to module 640. Then, a processor such as processor 520 can process the user interaction event information, analyze the information and modify or improve the operation of a CPE device based on the analysis. Examples of such processing of user interaction events and subsequent modification to improve operation of a CPE device that may be incorporated into the CPE device include the above-described features of modifying, selecting or adapting content (e.g., programming or advertising) and/or modifying a user interface such as an EPG based on user interactions.

Any or all of the preceding approaches may be used to modify and improve the operation of the system by, for example, adapting the content delivered such as delivering certain content at certain times, or modifying the user interface such as the program guide to display more relevant content based on the understanding of a user's use of the system. Given the teachings of the present principles provided herein, one of ordinary skill in the art will contemplate these and various other applications to which the present principles can be applied, while maintaining the spirit of the present principles.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof. Generally, the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random-access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles are not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method comprising:
accessing log of operations of a system to obtain a series of log entries associated with an active application executed by a processor included in the system;
comparing the series of log entries to a plurality of patterns of log entries stored in a database to identify a pattern corresponding to the series, wherein each of the plurality of patterns in the database is associated with an action by a user;
repeating the accessing and comparing steps to identify a plurality of actions by the user;
compiling the plurality of actions to create a record of an interaction of a user with the system;
processing the record to identify a characteristic of a user's behavior, wherein the active application comprises an over-the-top (OTT) application and the record of an interaction of a user with the system comprises a record of an interaction of the user with the OTT application; and
creating a modification of an operation of the system in response to the characteristic of the user's behavior, wherein the characteristic of the user's behavior comprises one or more of:
tracking the user's behavior across a plurality of OTT applications; or
identifying one or more factors having an influence on the user's selection of a particular OTT application or platform,
wherein the modification comprises at least one of modifying a content provided to the user and modifying a user interface of the system in response to the characteristic.

2. (canceled)

3. The method of claim 1 further comprising prior to the comparing step:
operating the system for a plurality of known actions by a user; and
processing the log entries of the system corresponding to the plurality of known actions by the user to create the plurality of patterns of log entries stored in the database.

4. (canceled)

5. (canceled)

6. (canceled)

7. The method of claim 1, wherein the one or more factors comprise one or more of a location of the user, a demographic attribute of the user, a broadband speed available to the user, and a time of day.

8. Apparatus comprising:
a memory; and
a processor coupled to the memory and being configured to:
access the memory to obtain from a log of operations of the apparatus stored in the memory a series of log entries associated with an active application executed by the processor;
compare the series of log entries to a plurality of patterns of log entries in a database stored in the memory to identify a pattern corresponding to the series, wherein each of the plurality of patterns in the database is associated with an action by a user;
repeat the access and compare operations to identify a plurality of actions by the user;
compile the plurality of actions to create a record of an interaction of a user with the apparatus;
process the record to identify a characteristic of a user's behavior, wherein the active application comprises an over-the-top (OTT) application and the record of an interaction of a user with the apparatus comprises a record of an interaction of the user with the OTT application; and
create a modification of an operation of the apparatus in response to the characteristic of the user's behavior wherein the characteristic of the user's behavior comprises one or more of:
tracking the user's behavior across a plurality of OTT applications; or
identifying one or more factors having an influence on the user's selection of a articular OTT application or platform,
wherein the modification comprises at least one of modifying a content provided to the user or modifying a user interface of the system in response to the characteristic.

9. (canceled)

10. The apparatus of claim 8 wherein the processor is further configured to, before the compare operation:
operate the apparatus for a plurality of known actions by a user; and
process the log entries of the apparatus corresponding to the plurality of known actions by the user to create the plurality of patterns of log entries stored in the database.

11. (canceled)

12. (canceled)

13. (canceled)

14. The apparatus of claim 8, wherein the one or more factors comprise one or more of a location of the user, a demographic attribute of the user, a broadband network speed available to the user, and a time of day.

15. A system comprising:
a server storing a database;
a user device in communication with the server and including:
a memory; and
a processor coupled to the memory and being configured to:
access the memory to obtain from a log of operations of the user device stored in the memory a series of log entries associated with an active application executed by the processor;
compare the series of log entries to a plurality of patterns of log entries in the database stored in the headend to identify a pattern corresponding to the series of log entries, wherein each of the plurality of patterns in the database is associated with an action by a user;
repeat the access and compare operations in the user device to identify a plurality of actions by the user; and wherein the server in the headend being configured to:
compile the plurality of actions to create a record of an interaction of a user with the user device;
process the record to identify a characteristic of the user's behavior, wherein the active application comprises an over-the-top (OTT) application and the record of an interaction of a user with the user device comprises a record of an interaction of the user with the OTT application; and
create a modification of an operation of the user device in response to the characteristic of the user's behavior wherein the characteristic of the user's behavior comprises one or more of:
tracking the user's behavior across a plurality of OTT applications; or
identifying one or more factors having an influence on the user's selection of a particular OTT application or platform,
wherein the modification comprises at least one of modifying a content provided to the user or modifying a user interface of the system in response to the characteristic.

16. The system of claim 15 wherein:
the processor is further configured to, before the compare operation, operate the user device for a plurality of known actions by a user; and
the server is further configured to process the log entries of the apparatus corresponding to the plurality of known actions by the user to create the plurality of patterns of log entries stored in the database.

17. (canceled)

18. (canceled)

19. (canceled)

20. The system of claim 15, wherein the one or more factors comprise one or more of a location of the user, a demographic attribute of the user, a broadband network speed available to the user, and a time of day.

21. A non-transitory storage media having computer readable programming code stored thereon for performing a method according to claim 1.
